(19) United States
(12) Patent Application Publication
(10) Pub. No.: US 2005/0246242 A1
(43) Pub. Date: Nov. 3, 2005

(54) System and method for collecting confidential customer information in conjunction with a live conversation between customer and vendor representative

(76) Inventor: Neil Forrest Proctor, Scottsdale, AZ (US)

Correspondence Address: GO DADDY GROUP, INC., 14455 NORTH HAYDEN ROAD, SUITE 219, SCOTTSDALE, AZ, 85260, US

(21) Appl. No.: 10/838,702

(22) Filed: May 3, 2004

(51) Int. Cl. G06F 17/60

(52) U.S. Cl. 705/26

(57) ABSTRACT

A system and method of the present invention allow collection of confidential customer information, such as credit card numbers, in conjunction with a live conversation between a Customer and a Vendor Representative. An adapter temporarily blocks the connection between the Customer and the Vendor Representative and collects confidential information from the Customer. The Vendor Representative is thus prevented from having access to the confidential customer information.

### FIELD OF THE INVENTION

The present invention relates, in general, to systems and methods for processing customer orders remotely and, in particular, to performing secured collection of confidential customer information in conjunction with a live conversation between a customer and a vendor representative.

### BACKGROUND OF THE INVENTION

Presently, there are multiple ways customers can remotely place their purchase orders with vendors. These include sending an order through the mail or fax, placing orders verbally with a vendor representative over the phone or placing an order via the Internet on a vendor's website. Typically, customers must pay for goods and services acquired during the placement of the purchase order. Often customers provide financial information, such as credit card, debit card, or a bank account number to vendors. This allows vendors to charge an appropriate card or bank account. One of the major concerns about the placement of orders remotely is the safety of confidential customer information. Potentially, a remote transaction could be intercepted by a third party allowing such party to obtain confidential customer information. Also an employee of a vendor, who is processing the transaction, may save confidential customer information and use it for unauthorized purposes.

Credit card fraud is a growing crime. In the United States alone, credit card fraud amounts to billions of dollars per year. Credit card fraud victims report hundreds of millions of dollars in losses to the Federal Trade Commission (FTC) every year.

The security in using credit cards for making remote purchases has improved, particularly for Internet purchases. For example, many vendors collect confidential customer information on their websites via encrypted transactions. The Secure Sockets Layer (SSL) is a commonly implemented protocol on vendors' websites for providing encrypted transactions. Further, companies are using encrypted files and database fields to limit access to the confidential customer information within the companies.

Collecting the confidential customer information over the phone is one area that did not experience much improvement in regards to confidentiality of customer information.

FIG. 1 depicts a typical setting, where a Customer 110 connects to a Vendor Representative 150 through a Customer Communication Means 120, a Communication Network 130, and a Vendor Representative Communication Means 140. Commonly, the Customer Communication Means 120 and the Vendor Representative Communication Means 140 are telephone apparatus; and the Communication Network 130 is a telephone network, such as the Public Switched Telephone Network (PSTN). After a connection is established the Vendor Representative 150 provides the Customer 110 with information about goods and services available for sale, their quality and specifications, sale promotions and discounts, etc. If the Customer 110 decides to purchase the goods or services, the Vendor Representative 150 collects information from the Customer 110. Typically, such information includes the customer's name, address, and method of payment, such as the customer's credit card number. Further, the Vendor Representative 150 populates the Finance Processing Module 160 and the Purchase Order Processing Module 170 with appropriate information. The Finance Processing Module 160 is a means for storing and processing financial information. The Purchase Order Processing Module 170 is a means for storing and processing purchase order information. The Finance Processing Module 160 and the Purchase Order Processing Module 170 are typically computer software programs that allow for storing information into a database.

The prior art system as illustrated in FIG. 1 does not allow secure collection of confidential customer information.

Referring to an alternative prior art system illustrated in FIG. 2 the Customer 110 can be connected to an Automated Communication Device 280, which collects the information from the Customer 110 and populates the information in the Finance Processing Module 160 and the Purchase Order Processing Module 170. The Automated Communication Device 280 is typically a computer connected to the telephone network, which allows the Customer 110 to listen to the instructions, navigate within the menu of options, and provide payment information to the vendor. The payment information may be provided via a touch tone telephone keyboard or by voice. If payment information is provided by voice, the Automated Communication Device 280 must have voice recognition capabilities. In this embodiment, the Customer 110 does not have the ability to acquire information about the range of goods and services offered by the vendor and the quality and specifications of the goods and services. Often the Customer 110 needs to know what products or services she/he is going to purchase, prior to using the Automated Communication Device 280. This embodiment is particularly suitable for customers who have an existing relationship with the vendor and have an established customer account on file with the vendor. Often, this embodiment is used for paying bills, invoices and statements, when the Customer 110 has already purchased the product or service or is paying for the next time period (mortgage and credit payments, utility bills, telephone bills, etc.).

The prior art system as illustrated in FIG. 2 cannot be used in conjunction with a live conversation between the customer and the vendor representative.

Therefore, it is desired to create a system that allows secure collection of confidential customer information in conjunction with a live conversation between a customer and a vendor representative.

### SUMMARY OF THE INVENTION

The limitations cited above and others are substantially overcome through the system and method disclosed herein. A system and method of the present invention allow collection of confidential customer information, such as credit card numbers, without a Vendor Representative having access to the confidential customer information. When the Vendor Representative activates an Adapter, the Adapter temporarily blocks the connection between a Customer and the Vendor Representative and collects confidential information from the Customer.

The proposed system and method would allow companies to reduce their liability related to financial fraud, create a better comfort level for the customers to participate in placing purchase order remotely, and, as a result, improve sales of products and services.

The above features and advantages of the present invention will be better understood from the following detailed description taken in conjunction with the accompanying drawings.

### BRIEF DESCRIPTION OF THE DRAWINGS

FIG. 1 represents a block diagram of a prior art system, which allows a Customer to place a purchase order with a Vendor Representative, where the Vendor Representative has access to confidential customer information.

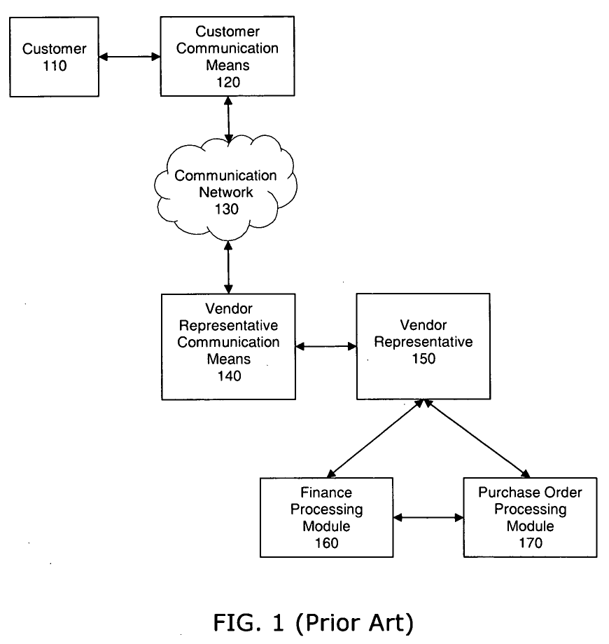

FIG. 2 represents a block diagram of a prior art system, which allows a Customer to place a purchase order without a Vendor Representative participating in the transaction.

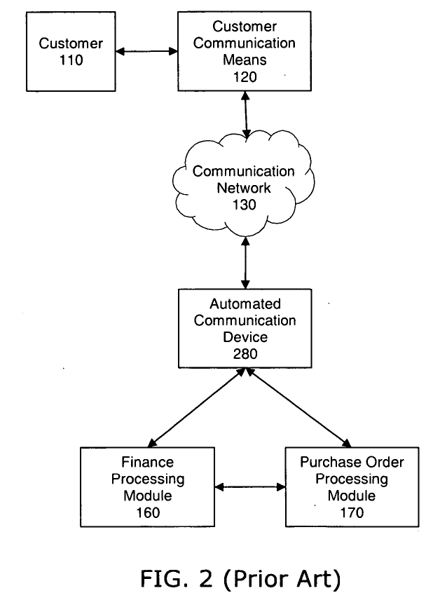

FIG. 3 represents a block diagram of a system, which allows a Customer to place a purchase order with a Vendor Representative, where the Vendor Representative does not have access to confidential customer information.

FIG. 4 represents a flow chart illustrating a method of using the system of FIG. 3.

### DETAILED DESCRIPTION AND PREFERRED EMBODIMENT

The present invention will now be discussed in detail with regard to the attached drawing figures which were briefly described above. In the following description, numerous specific details are set forth illustrating Applicant's best mode for practicing the invention and enabling one of ordinary skill in the art to make and use the invention. It will be obvious, however, to one skilled in the art that the present invention may be practiced without many of these specific details. In other instances, well-known machines and method steps have not been described in particular detail in order to avoid unnecessarily obscuring the present invention. Unless otherwise indicated, like parts and method steps are referred to with like reference numerals.

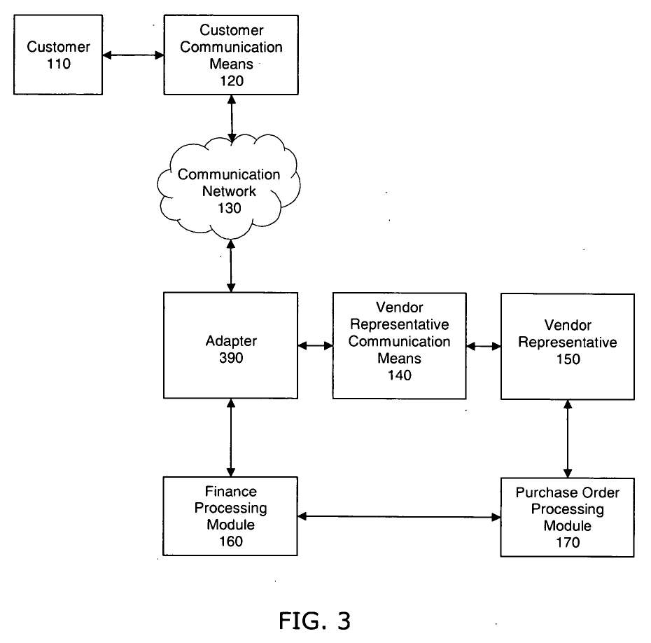

FIG. 3 depicts a system in accordance with the teachings of the present invention. The system includes a Customer 110, a Customer Communication Means 120, a Communication Network 130, an Adapter 390, a Vendor Representative Communication Means 140, a Vendor Representative 150, a Finance Processing Module 160, and a Purchase Order Processing Module 170. Typically the Customer 110 may be an individual or an agent for an entity. Typically the Vendor Representative 150 may be an individual or an agent for an entity. The Customer Communication Means 120 and the Vendor Representative Communication Means 140 are means for communicating and may include, for example, telephones, mobile phones, beepers, pagers, computers, personal digital assistants (PDA), microphones, speakers, video cameras, video displays, and other communication devices, or combinations thereof. The Communication Network 130 may include a telephone network and a computer network or combinations thereof. The telephone network may include the Public Switched Telephone Network (PSTN), Plain Old Telephone Service (POTS), Integrated Services Digital network (ISDN), Asymmetric Digital Subscriber Line (ADSL) network, Private Branch Exchange (PBX), and Internet Protocol (IP) network, or combinations thereof. The computer network may include Local Area Network (LAN), Wide Area Network (WAN), and global area networks, such as the Internet, or combinations thereof.

The Adapter 390 may include a standalone device, a device within a vendor's PBX, a software program residing on the vendor's PBX, a device on a Vendor Representative's computer (such as modem), and a software program residing on the Vendor Representative's computer, or combinations thereof. The Adapter 390 has the ability to block a communication link between the Customer 110 and Vendor Representative 150, and collect confidential information from the Customer 110 without allowing access to the confidential customer information by the Vendor Representative 150. If the Customer 110 uses a telephone apparatus for a live conversation with the Vendor Representative 150, she/he can use a touch tone telephone keyboard to enter the confidential information. Alternatively, the vendor may implement a voice recognition feature in the Adapter 390, which would allow the Customer 110 to provide information by voice. If the Customer 110 uses a computer for short text messaging conversation with the Vendor Representative 150 (so called chat), she/he can use a computer keyboard to enter the information.

The Finance Processing Module 160 is a means for storing and processing financial information. The Purchase Order Processing Module 170 is a means for storing and processing purchase order information. The Finance Processing Module 160 and the Purchase Order Processing Module 170 are typically computer software programs that allow information to be stored into a database. The Finance Processing Module 160 may perform a function of checking the validity of credit and debit card numbers. The checking function may include, as non-limiting example, (I) a verification of the card prefix number (to match to a particular card system), (2) a verification of the length of the card number, (3) a Luhn's Algorithm validation, and (4) a validation with a card issuer or a card processing organization. For better security, the Finance Processing Module 160 may save the confidential customer information in an encrypted form.

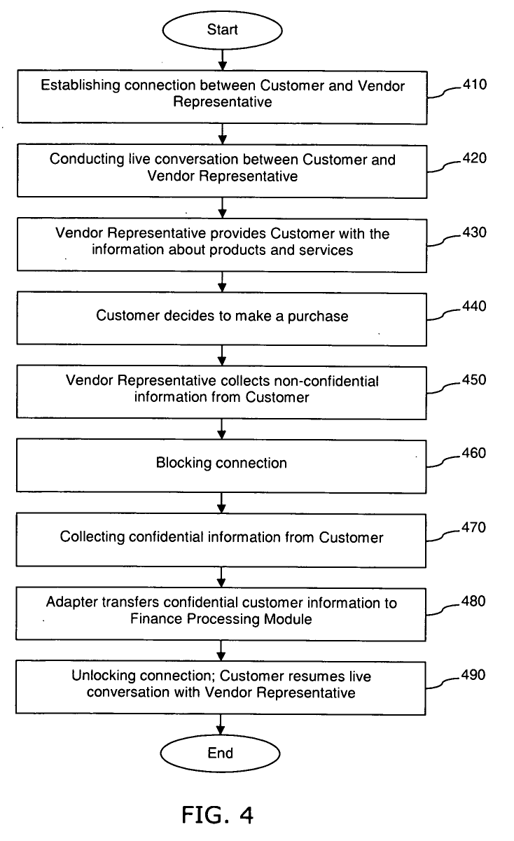

FIG. 4 illustrates a preferred method of using the system described above and illustrated in FIG. 3. The Customer 110 establishes a connection with the Vendor Representative 150 (Step 410). The connection is established through the Customer Communication Means 120, the Communication Network 130, the Adapter 390, and the Vendor Representative Communication Means 140. When the Customer 110 establishes the connection with the Vendor Representative 150, the Adapter 390 allows direct communication between the Customer 110 and the Vendor Representative 150. The Customer 110 and the Vendor Representative 150 conduct a live conversation (Step 420). The live conversation between the Customer 110 and the Vendor Representative 150 may include an audio conversation, such as a telephone conversation, a video and audio conversation, and a short text messages conversation, such as a chat, or combinations thereof.

The Vendor Representative 150 may provide the Customer 110 with the information about the products and services available for purchase from the Vendor (Step 430). If the Customer 110 decides to make a purchase (Step 440), the Vendor Representative 150 may collect non-confidential information from the Customer 110 (Step 450), transfer non-confidential customer information to the Purchase Order Processing Module 170, and activate the Adapter 390. The Adapter 390 may be activated by a switch or a button on the Adapter 390 if the Adapter 390 is a standalone device. The Adapter 390 may also be activated by a Vendor Representative's computer, if the Adapter 390 is a device or a software program on the Vendor Representative's computer or a standalone device connected to the Vendor Representative's computer. The Adapter 390 may also be activated by forwarding a Customer's call to the vendor's PBX if the Adapter 390 is a device or a software program on the vendor's PBX.

Alternatively, the Adapter 390 may be activated by the Customer 110. The Customer 110 may dial a specific combination on the touch tone telephone keyboard during the telephone conversation; or type a specific combination on a computer keyboard or click on a link or button on a computer screen if the conversation was a short text messages conversation.

When the Adapter 390 is activated, it may block the connection between the Customer 110 and the Vendor Representative 150 (Step 460) and collect confidential information from the Customer 110 (Step 470). Typically confidential customer information will be provided to the Adapter 390 by the Customer 110 using a computer keyboard, a touch tone telephone keyboard or verbally if the Adapter 390 has voice recognition capabilities.

Further, the Adapter 390 may transfer confidential customer information to the Finance Processing Module 160 (Step 480). The Finance Processing Module 160 or the Adapter 390 may have the capabilities of validating confidential customer information and notifying the Customer 110 with the results of such validation.

Optionally, the connection can be unblocked and the Customer 110 may resume the live conversation with the Vendor Representative 150 after supplying her/his confidential information to the Adapter 390 (Step 490). The Adapter 390 can unblock the connection automatically when valid information has been provided by the Customer 110 or manually by the Customer 110 or by the Vendor Representative 150. The Vendor Representative 150 may receive notification regarding the results of the collection process of the confidential customer information by the Adapter 390.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

1. A system for collecting confidential customer information in conjunction with a live conversation between a Customer and a Vendor Representative, comprising:
a Customer,
a Customer Communication Means,
a Communication Network,
an Adapter,
a Vendor Representative Communication Means,
a Vendor Representative;
wherein a connection can be established between said Customer and said Vendor Representative for conducting a live conversation; wherein said connection can be established through said Customer Communication Means, said Communication Network, said Adapter, and said Vendor Representative Communication Means; wherein
said Adapter has an ability to block said connection between said Customer and said Vendor Representative and collect a confidential customer information from said Customer.

2. The system of claim 1, wherein said Customer Communication Means is a telephone apparatus.

3. The system of claim 1, wherein said Vendor Representative Communication Means is a telephone apparatus.

4. The system of claim 1, wherein said Customer Communication Means is a computer.

5. The system of claim 1, wherein said Vendor Representative Communication Means is a computer.

6. The system of claim 1, wherein said Communication Network is a telephone network.

7. The system of claim 6, wherein said telephone network is the Public Switched Telephone Network.

8. The system of claim 1, wherein said Communication Network is a computer network.

9. The system of claim 8, wherein said computer network is the Internet.

10. The system of claim 1, wherein said Adapter is a standalone device.

11. The system of claim 1, wherein said Adapter is a device within a vendor's Private Branch Exchange.

12. The system of claim 1, wherein said Adapter is a software program residing on a vendor's Private Branch Exchange.

13. The system of claim 1, wherein said Adapter is a device on a Vendor Representative's computer.

14. The system of claim 13, wherein said device on said Vendor Representative's computer is a modem.

15. The system of claim 1, wherein said Adapter is a software program residing on a Vendor Representative's computer.

16. The system of claim 1, wherein said Adapter can be activated to block said connection between said Customer and said Vendor Representative by said Customer.

17. The system of claim 1, wherein said Adapter can be activated to block said connection between said Customer and said Vendor Representative by said Vendor Representative.

18. The system of claim 1, wherein said Adapter has an ability to unblock said connection between said Customer and said Vendor Representative to resume said live conversation.

19. The system of claim 18, wherein said Adapter can be instructed to unblock said connection between said Customer and said Vendor Representative by said Customer.

20. The system of claim 18, wherein said Adapter can be instructed to unblock said connection between said Customer and said Vendor Representative by said Vendor Representative.

21. The system of claim 18, wherein said Adapter can unblock said connection between said Customer and said Vendor Representative automatically after said confidential customer information was collected.

22. The system of claim 1, further comprising a means for storing and processing financial information.

23. The system of claim 22, wherein said means for storing and processing financial information is a computer software program.

24. The system of claim 22, wherein said means for storing and processing financial information is a computer software program coupled with a database.

25. The system of claim 22, wherein said means for storing and processing financial information has an ability to validate customer financial information.

26. The system of claim 1, further comprising a means for storing and processing purchase order information.

27. The system of claim 26, wherein said means for storing and processing purchase order information is a computer software program.

28. The system of claim 26, wherein said means for storing and processing purchase order information is a computer software program coupled with a database.

29. A method for collecting confidential customer information in conjunction with a live conversation between a Customer and a Vendor Representative, comprising the steps of:
establishing a connection between a Customer and a Vendor Representative,
conducting a live conversation between said Customer and said Vendor Representative,
blocking said connection between said Customer and said Vendor Representative,
collecting a confidential customer information from said Customer.

30. The method of claim 29, wherein said step of establishing said connection between said Customer and said Vendor Representative comprises:
said Customer initiating said establishing of said connection to said Vendor Representative,
said Vendor Representative accepting said establishing of said connection from said Customer.

31. The method of claim 29, wherein said step of establishing said connection between said Customer and said Vendor Representative comprises:
said Vendor Representative initiating said establishing of said connection to said Customer,
said Customer accepting said establishing of said connection from said Vendor Representative.

32. The method of claim 29, wherein said live conversation is an audio conversation.

33. The method of claim 32, wherein said audio conversation is a telephone conversation.

34. The method of claim 29, wherein said live conversation is a short text messages conversation.

35. The method of claim 34, wherein said short text messages conversation is a chat conversation.

36. The method of claim 29, wherein said live conversation is a video and audio conversation.

37. The method of claim 29, wherein said step of blocking said connection between said Customer and said Vendor Representative is initiated by said Customer.

38. The method of claim 29, wherein said step of blocking said connection between said Customer and said Vendor Representative is initiated by said Vendor Representative.

39. The method of claim 29, further comprising a step of:
unblocking said connection between said Customer and said Vendor Representative.

40. The method of claim 39, wherein said step of unblocking said connection between said Customer and said Vendor Representative is initiated by said Customer.

41. The method of claim 39, wherein said step of unblocking said connection between said Customer and said Vendor Representative is initiated by said Vendor Representative.

42. The method of claim 39, wherein said step of unblocking said connection between said Customer and said Vendor Representative is performed automatically after said collecting of said confidential customer information from said Customer was completed.

43. The method of claim 39, further comprising a step of:
resuming said live conversation.
